(19) United States
(12) Patent Application Publication
(10) Pub. No.: US 2023/0401037 A1
(43) Pub. Date: Dec. 14, 2023

(54) OPTIMIZATION TECHNIQUE FOR MODULAR MULTIPLICATION ALGORITHMS

(71) Applicant: Intel Corporation, Santa Clara, CA (US)

(72) Inventors: Erdinc OZTURK, Paris (FR); Kirk S. YAP, Westborough, MA (US); Tomasz KANTECKI, Ennis (IE)

(21) Appl. No.: 18/237,859

(22) Filed: Aug. 24, 2023

Related U.S. Application Data
(60) Provisional application No. 63/469,173, filed on May 26, 2023.

(51) Int. Cl. G06F 7/72

(52) U.S. Cl. CPC G06F 7/722; G06F 7/728

(57) ABSTRACT

Methods and apparatus for optimization techniques for modular multiplication algorithms. The optimization techniques may be applied to variants of modular multiplication algorithms, including variants of Montgomery multiplication algorithms and Barrett multiplication algorithms. The optimization techniques reduce the number of serial steps in Montgomery reduction and Barrett reduction. Modular multiplication operations involving products of integer inputs A and B may be performed in parallel to obtain a value C that is reduced to a residual RES. Modular multiplication and modular reduction operations may be performed in parallel. The number of serial steps in the modular reductions are reduced to L, where L serial steps, where w is a digit size in bits, and L is a number of digits of operands=[k/w].

### CROSS-REFERENCE TO RELATED APPLICATION

This application claims the benefit of the filing date of U.S. Provisional Application No. 63/469,173 filed May 26, 2023, entitled “OPTIMIZATION TECHNIQUE FOR MODULAR MULTIPLICATION ALGORITHMS” under 35 U. S. C. § 119(e). U.S. Provisional Application No. 63/469,173 is further incorporated herein in its entirety for all purposes.

### BACKGROUND INFORMATION

Modular multiplication is a very important component of most cryptographic constructions, such as RSA (Rivest-Shamir-Adleman) and ECC (Elliptic-Curve Cryptography) used in TLS/web connections for public-key cryptography today. Future PQC (Post Quantum Crypto) or FHE (Fully Homomorphic Encryption) algorithm standards also rely on modular multiplication.

Examples of modular multiplication include Montgomery module multiplication, more commonly referred to as Montgomery multiplication, and Barrett Multiplication. Montgomery modular multiplication relies on a special representation of numbers called Montgomery form. The algorithm uses the Montgomery forms of a and b to efficiently compute the Montgomery form of ab mod N. The efficiency comes from avoiding expensive division operations. Classical modular multiplication reduces the double-width product ab using division by N and keeping only the remainder. This division requires quotient digit estimation and correction. The Montgomery form, in contrast, depends on a constant R>N which is coprime to N, and the only division necessary in Montgomery multiplication is division by R. The constant R can be chosen so that division by R is easy, significantly improving the speed of the algorithm. In practice, R is always a power of two, since division by powers of two can be implemented by bit shifting.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic representation of a Montgomery multiplication algorithm using k-bit inputs;

FIG. 2 is a block representation of a single step of a Montgomery Multiplication algorithm;

FIG. 3 is a schematic representation of a Montgomery multiplication algorithm using an 2 k-bit inputs;

FIG. 4 is a schematic representation of an optimized Montgomery multiplication algorithm, according to one embodiment;

FIG. 5 is a schematic representation of a Barrett multiplication algorithm using an existing approach;

FIG. 6 is a schematic representation of an optimized Montgomery multiplication algorithm, according to one embodiment;

FIG. 7 is schematic diagram of a first exemplary IPU including two enhanced optical modules, according to one embodiment;

FIG. 7a is a schematic diagram illustrating a second exemplary IPU including two enhanced optical modules, wherein the Ethernet NIC functionality is implemented in the FPGA;

FIG. 8 is a schematic diagram illustrating a smartNIC including two enhanced optical modules; and

FIG. 9 is a diagram illustrating an example computing system that may be used to practice one or more embodiments disclosed herein.

### DETAILED DESCRIPTION

Embodiments of methods and apparatus for optimization technique for modular multiplication algorithms are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

There are two well-known modular multiplication algorithms: Montgomery and Barrett. For large sizes, word-level software and hardware implementations of these algorithms are utilized. For these word-level algorithms, multiplication and reduction sections present similar performance.

Word-level modular multiplication involves many core multiplication operations, and most of these core multiplications can be parallelized. Modular multiplication consists of two main operations: multiplication and reduction.

There are several core multiplications in the multiplication operation. The core multiplications are highly parallelizable since they are —independent multiplications. However, word-level reduction is a serial process and is hard to parallelize. The more serial steps it includes (the bigger the number), the more inefficiency it will introduce to the performance of modular multiplication.

Montgomery Multiplication

Montgomery Multiplication and Reduction operations can be defined and implemented in many ways. To be able to demonstrate our approach, we utilize a word-level approach. First, we define preliminaries:
k: Bit-length of operands
w: word size (in bits)
L: number of digits of operands=[k/w]
M: k-bit modulus (Montgomery Modulus)
R: 2^{L*w} mod M (Montgomery Radix)
mu=−M⁻¹ mod 2^{w} (w-bit Montgomery constant)
A[i]: i^{th} word of A

Montgomery Reduction can be utilized after full multiplication of the operands. This is defined as follows:
Input: C (2 k-bit integer, C=A*B)
   Inputs: M, mu
   Output: MR(C,M) ° C.*R⁻¹ mod M
   for i from 0 to (L-1):
      T=C[0]*mu//discard T[1]
      C=C+T[0]*M //C[0] is zero
      C=C>>w//at each step of the for loop,
         divide the result by 2¹.

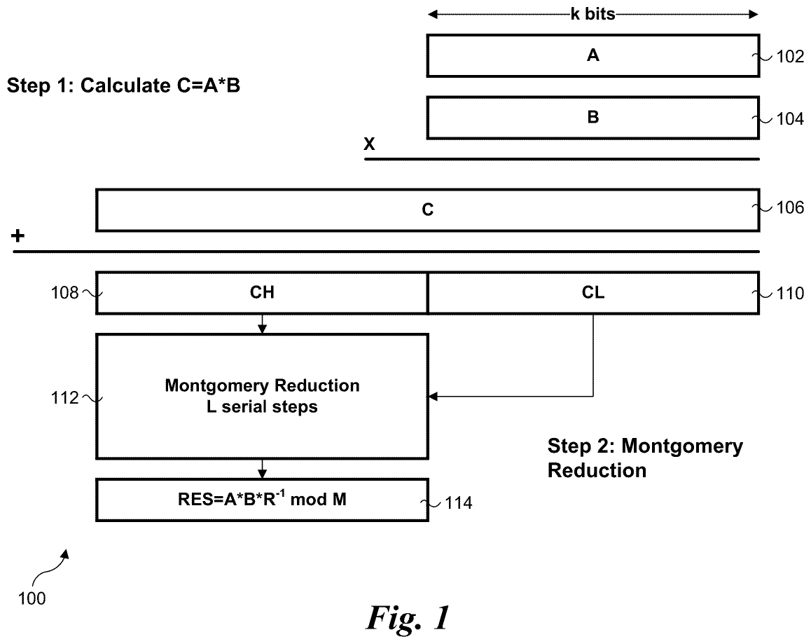

A schematic representation 100 of the foregoing is depicted in FIG. 1. k-bit values for A and B are loaded into registers 102 and 104 and multiplied to obtain C, as shown in a block 106. CH, the upper (high) k/2 bits of C are loaded into a register 108 while CL, the lower k/2 bits of C are loaded into a register 110. Montgomery Reduction is then performed using L serial steps in a block 112 to output RES=A*B*R⁻¹ mod M, as shown in a block 114

It should be noted that this algorithm is not exactly representing Montgomery Reduction, but it is representing an Almost Montgomery Reduction operation. In the Almost Montgomery Reduction operation, the result is not less than the modulus M, but it is exactly k bits. If k/w is not an integer, the operation guarantees an L-digit result, eliminating the need for further checking.

Montgomery Multiplication operation interleaves multiplication and reduction components of the operation. Montgomery Multiplication algorithm can be defined as follows:
Input: A,B (k-bit integers)
Inputs: M, mu
Output: MM(A,B,M)° A*B*R⁻¹ mod M
C=0
for i from 0 to (L-1):
   C=C+A*B[i]
   T=C[0]*mu/discard T[1]
   C=C+T[0]*M //C[0] is zero
   C=C>>w//at each step of the for loop,
      divide the result by 2^{w}.

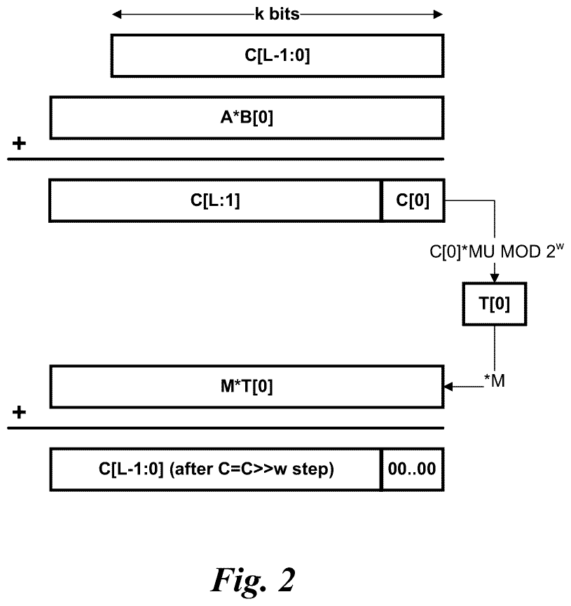

A single step of the Montgomery Multiplication algorithm is depicted in FIG. 2.

To simplify presentation, Montgomery Multiplication Algorithm can be defined over 2 k-bit integers as follows:
Input: A=AH*2^{k}+AL
Input: B
Input: M, Montgomery constants
Step 1: Calculate C=A*B
   C=AL*B+AH*B*2^{k}
Step 2: Calculate RES=C*R⁻¹ mod M
   For the reduction step, the number of serial steps can be calculated as:
w: word size
L: k/w (Assume k is a multiple of w, again for simple presentation, which could easily be generalized)
   and R can be calculated as:
R: 2^{2*k}

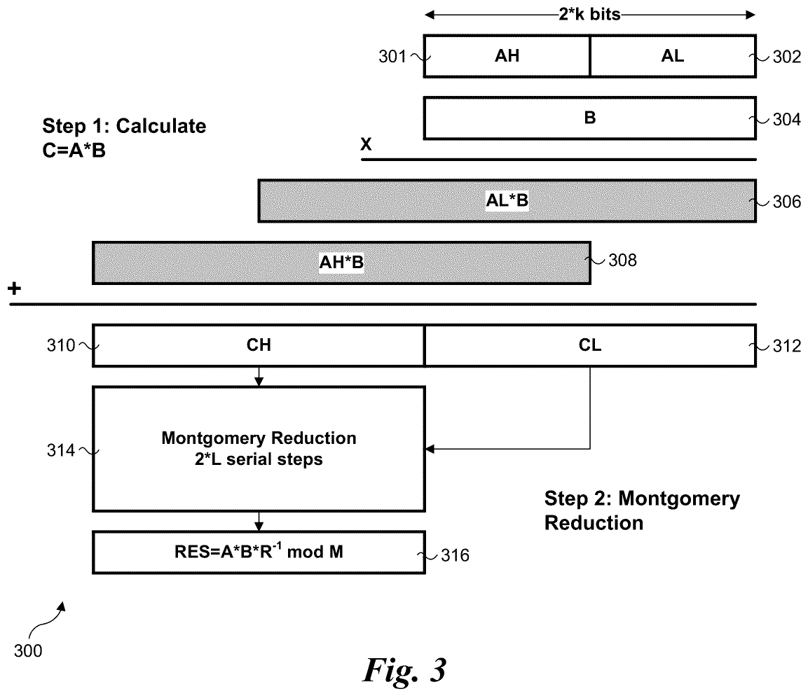

A schematic representation 300 of the foregoing is shown in FIG. 3. A, the first input comprising a 2*k-bit integer is split into two parts, where AH, comprising the high k bits of A is loaded into a register 301, AL, comprising the low k bits of A is loaded into a second register 302, with input B being loaded into a third register 304. As shown in blocks 306 and 308, AL*B and AH*B are calculated in parallel. C is then calculated by adding the output of blocks 306 and 308.

Step 2 of the Montgomery reduction begins with CH and CL in registers 310 and 312, where CH is the high 2*k bits of C(CH=C/R) and CL(CL=C mod R) is the low 2*k bits of C. CH and CL are input to a block 314 in which Montgomery reduction is performed using 2*L serial steps using a known algorithm, with the particular algorithm being outside the scope of this disclosure. The output block 314 is RES, as depicted in a block 316.

In terms of A and B, RES can be written as follows:
RES=C*R⁻¹ mod M
   =(AL*B+AH*B*2^{k})*R⁻¹ mod M
   =(AL*B+AH*B*2^{k})*2^{-2*k} mod M
   =(AL*B*2^{-2*k} mod M+AH*B*2^{k}*2^{-2*k} mod M) mod M
   =(AL*B*2^{-2*k} mod M+AH*B*2^{-k} mod M) mod M

Assume we have a precomputed constant K_{M}, which is derived from operand B:
Precompute: K_{M}=B*2^{-k} mod M
   Then, RES can be rewritten as follows:
RES=(AL*K_{M}*2^{-k} mod M+AH*B*2^{-k} mod M) mod M
   =(AL*K_{M}+AH*B)*2^{-k} mod M

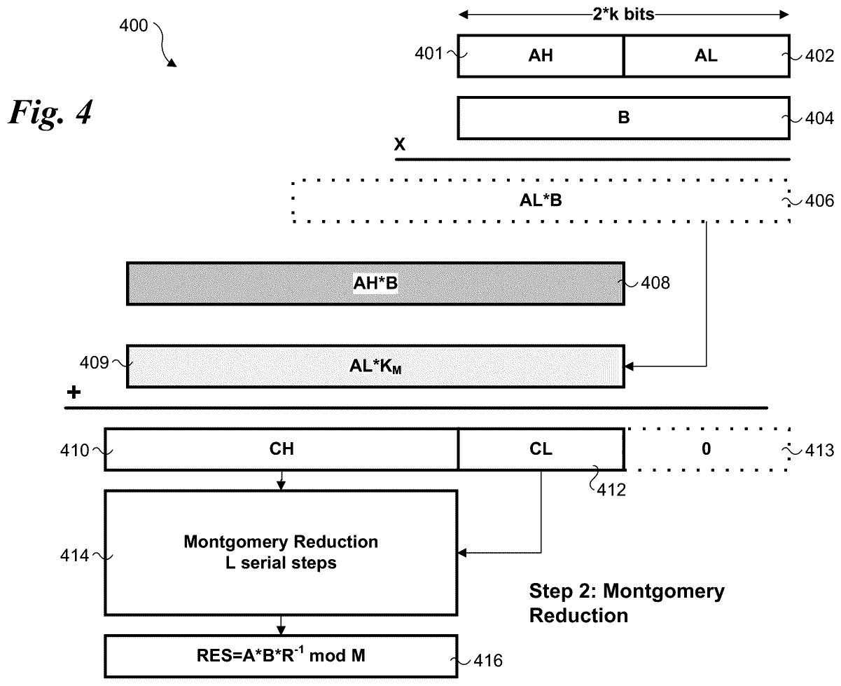

FIG. 4 shows a representation of an optimized Montgomery multiplication algorithm 400 using this approach. In a manner similar to described above for FIG. 3, AH is loaded into a register 401, AL is loaded into a second register 402, with input B is loaded into a third register 404. Under the optimized Montgomery multiplication scheme, rather than calculate AL*B, as depicted in a block 406, AL*K_{M} is calculated in a block 409. AH*B is calculated in a block 408, with the operations in blocks 408 and 409 being performed in parallel. As discussed above, K_{M} is precomputed as B*2^{-k} mod M. C is then calculated by adding the output of blocks 408 and 409.

When C is calculated in this manner, the value of the lower k bits of C is ‘0’, as shown in a block 413. Meanwhile, the upper 2*k bits (CH) are loaded into block 410 and the upper k bits of CL are loaded into a block 412. As before, CH and CL are fed into a Montgomery reduction block 414. However, since the lower k bits of CL are ‘0’, the Montgomery reduction can be performed in L serial steps, halving the 2*L serial steps required under the conventional Montgomery reduction in FIG. 3. The output of block 414 is RES, as shown in a block 416.

An embodiment of the Montgomery Multiplication algorithm that interleaves multiplication and reduction components is defined as follows:
Inputs: A,B
   Inputs: M,mu,K_{M}(K_{M}=B*(2^{-(L)*w}) mod M)
   Output: MM(A,B,M)° A*B*R⁻¹ mod M
   AL=A[L-1:0]
   AH=A[2*L-1,L]
   C=0
   for i from 0 to (L-1):
      C=C+AL[i]*K_{M}+AH[i]*B
      T=C[0]*mu//discard T[1]
      C=C+T[0]*M //C[0] is zero
      C=C>>w//at each step of the for loop,
         divide the result by 2^{w}.

Barrett Multiplication

The Barrett Multiplication algorithm can be defined over 2 k-bit integers as follows:
Input: A=AH*2 k+AL
Input: B
Input: M, Barrett constants
Step 1: Calculate C=A*B
   C=AL*B+AH*B*2^{k}
Step 2: Calculate RES=C mod M

For the reduction step, the number of serial steps can be calculated as:
w: word size
L: k/w (Assume k is a multiple of w)

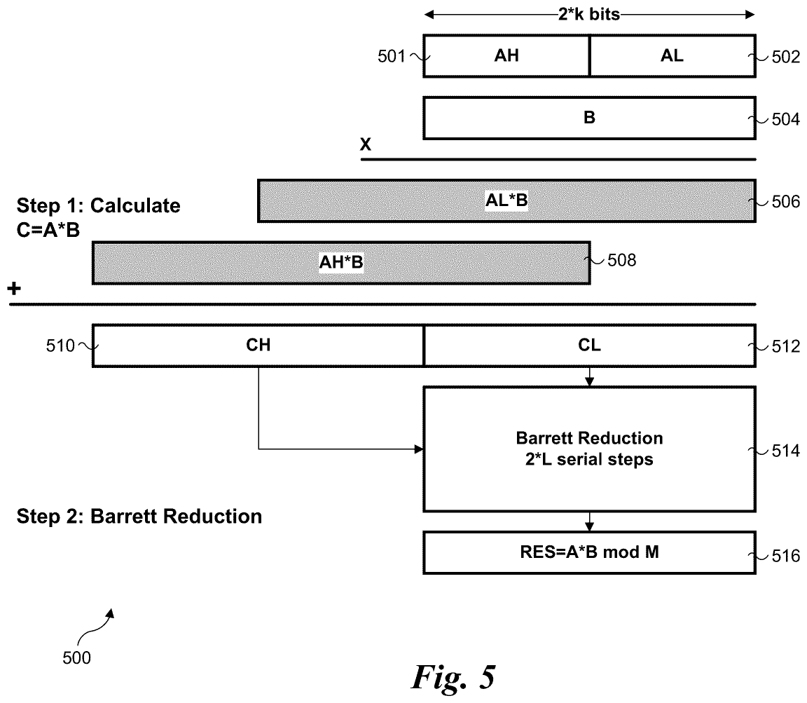

A representation 500 of an example of a conventional Barrett Multiplication algorithm is shown in FIG. 5. AH is loaded into a register 501 and AL loaded into a register 502, while B is loaded into a register 504. In respective blocks 506 and 508 AL*B and AH*B are calculated in parallel, and C is calculated as AL*B+AH*B*2^{k} by adding the output of blocks 506 and 508.

CH, the upper half (C/2^{k}) of C is loaded into a block 510 while CL, the lower half (C mod 2^{k}) of C is loaded into a block 512. CH and CL are provided as inputs to a block 514 in which Barrett reduction is performed using 2*L serial steps using a known algorithm, with the particular Barrett reduction algorithm being outside the scope of this disclosure. The output of block 514 is RES, as shown in a block 516.

In terms of A and B, RES can be written as follows:
RES=C mod M
=(AL*B+AH*B*2^{k}) mod M

Assume we have a precomputed constant K_{B}, which is derived from operand B:
Precompute: K_{B}=B*2^{k} mod M
   Then, RES can be rewritten as follows:
RES=(AL*B+AH*B*2^{k}) mod M
   =(AL*B+AH*K_{B}) mod M

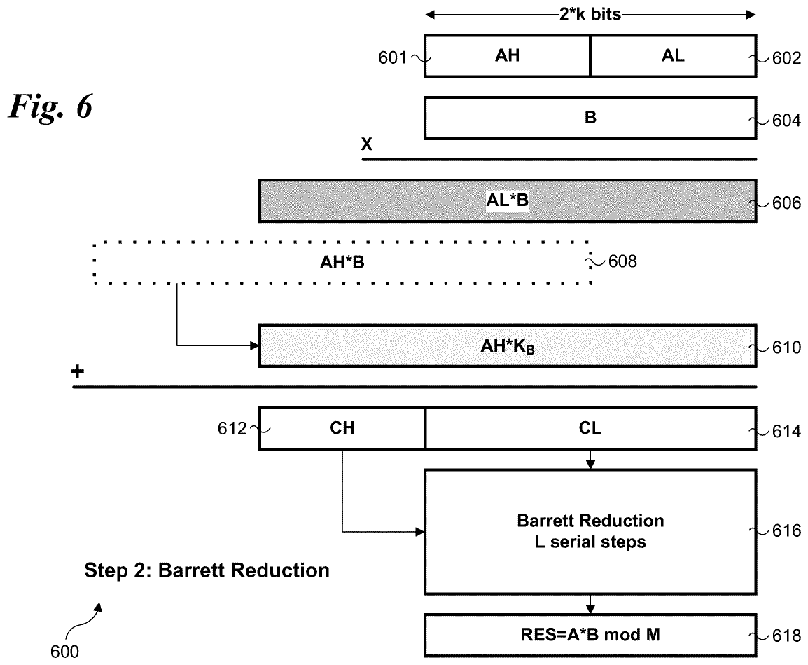

A schematic representation of an optimized Barrett multiplication algorithm using this approach for calculation RES is shown in FIG. 6. As before, AH is loaded into register 601, AL is loaded into register 602, and B is loaded into register 604. As with the conventional approach, AL*B is calculated in a block 606. However, rather than calculate AH*B in a block 608, AH*K_{B} is calculated in a block 610, with the operations of blocks 606 and 610 being performed in parallel. C is then calculated by adding the outputs of blocks 606 and 610.

In the Barrett reduction step, CH is loaded in block 612 and CL is loaded in block 614. In this case, the upper k bits of CH are ‘0’s, leaving the lower k bits of CH to be operated on. As a result, the Barrett reduction in a block 616 only requires L serial steps rather than L*2 serial steps. The output of block 616 is RES, as shown in a block 618. Under the optimized Barret multiplication algorithm of FIG. 6 the number of serial steps L in the Barrett reduction is cut in half when compared with the conventional Barrett reduction in FIG. 5.

### Exemplary Use Cases

Generally, the improved Montgomery and Barrett algorithms may be implemented via execution of instructions on processors used in various types of devices comprising communication endpoints. For example, such communication endpoints may include computers/servers or network devices installed in such computers/servers, such as NICs (Network Interface Controllers), SmartNICs, Infrastructure Processing Units (IPUs), Data Processing Units (DPUs), and Edge Processing Units (EPUs). Additional use cases include but are not limited to use in encrypted memory applications, encrypted network applications, for authentication, and access control. In addition to execution of instructions on processors, all or part of the improved Montgomery and Barrett algorithms may be implemented using programmable logic, such as but not limited to using a Field Programmable Gate Array (FPGA), Application Specific Integrated Circuits (ASICs), and other types of embedded logic.

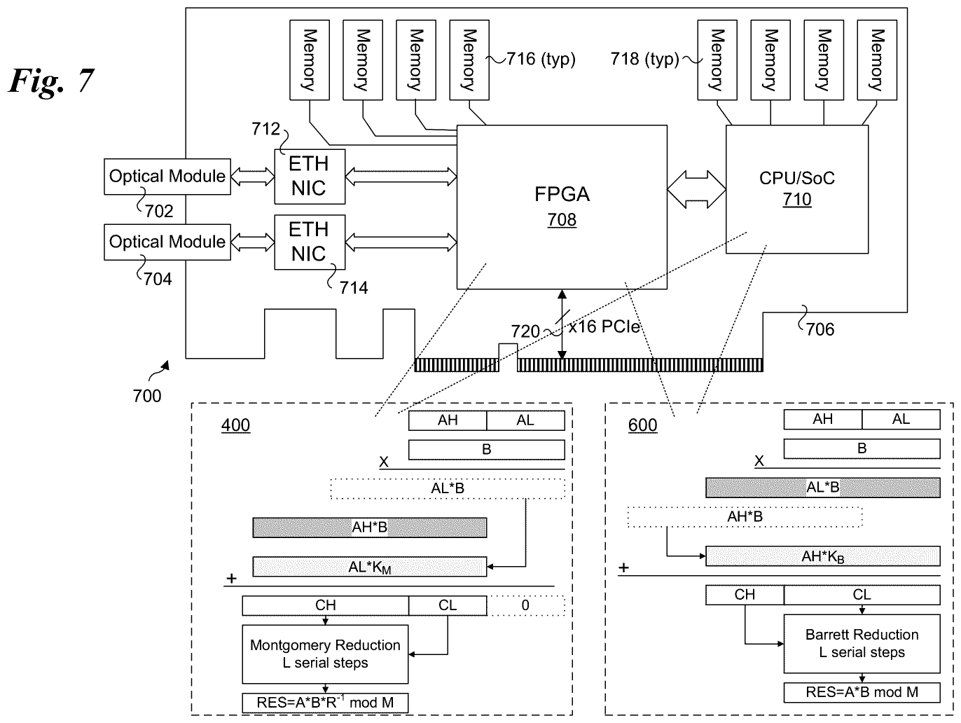

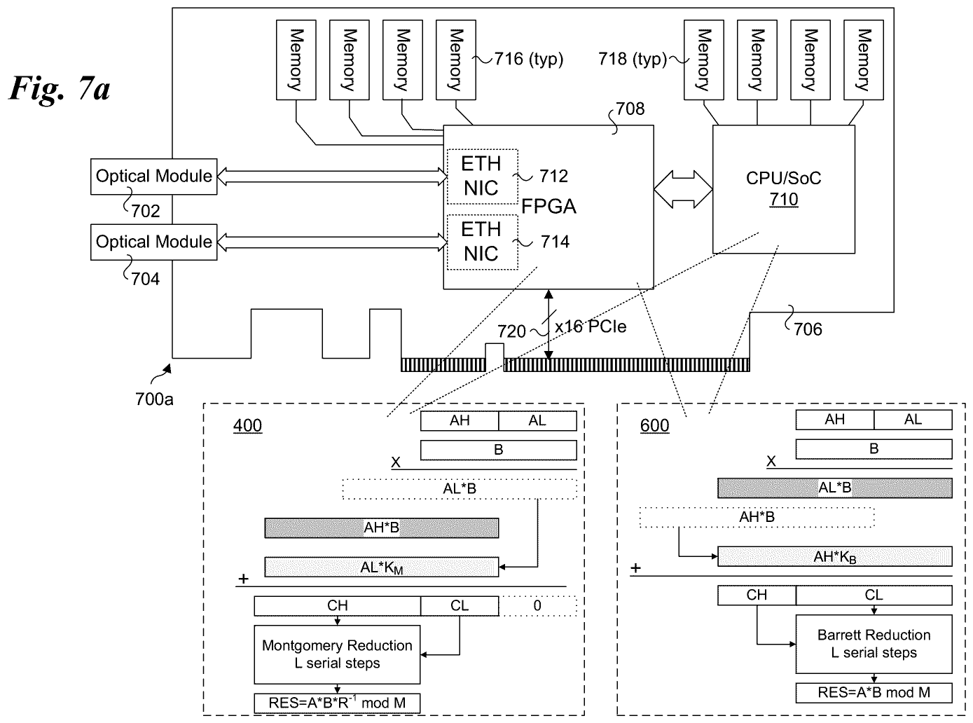

FIGS. 7 and 7a shows respective infrastructure processor units (IPUs) 700 and 700a, each including two optical modules 702 and 704. In the illustrated embodiment of FIG. 7, IPU 700 comprises a Peripheral Component Interconnect Express (PCIe) card including a circuit board 706 having a PCIe edge connector 720 to which various integrated circuit (IC) chips and enhanced optical modules 702 and 704 are mounted. Alternatively, PCIe edge connector 720 may be replaced by another I/O interface, such as but not limited to COMPUTE EXPRESS LINK™ (CXL). The IC chips include an FPGA 708, a CPU/SoC (System on a Chip) 710, a pair of Ethernet NICs 712 and 714, and memory chips 716 and 718. Programmed logic in FPGA 708 and/or execution of software on CPU/SoC 710 may be used to implement various IPU functions, including implementation of an optimized Montgomery and/or Barrett Multiplication algorithm in accordance with the embodiments described and illustrated herein. FPGA 708 may include logic that is pre-programmed (e.g., by a manufacturing) and/or logic that is programmed in the field. For example, logic in FPGA 708 may be programmed by a host CPU for a platform in which IPU 700 is installed. IPU 700 may also include other interfaces (not shown) that may be used to program logic in FPGA 708.

Under an IPU 700a shown in FIG. 7a, the functionality associated with Ethernet NICs 712 and 714 is implemented in FPGA 708 by (pre-) programming associated logic in the FPGA. Optionally, similar functionality may be implemented using an ASIC or an SoC.

CPU/SoC 710 employs a System on a Chip including multiple processor cores. Various CPU/processor architectures may be used, including x86 and ARM architectures. In one non-limiting example, CPU/SoC 710 comprises an Intel® Xeon® processor. Software executed on the processor cores may be loaded into memory 718, either from a storage device (not shown), for a host, or received over a network coupled to enhanced optical module 702 and 704.

As further shown in each of FIGS. 7 and 7a, the optimized Montgomery multiplication algorithm 400 and/or the optimized Barrett multiplication algorithm 600 may be implemented by programming logic in FPGA 708 or via execution of software/firmware on CPU/SoC 710.

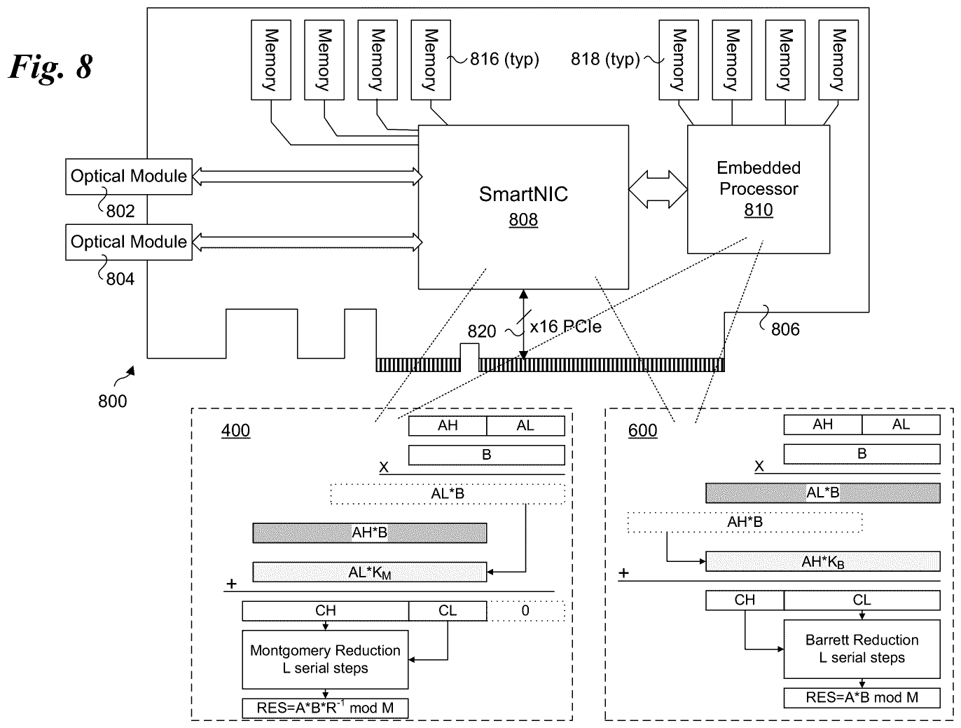

FIG. 8 shows a SmartNIC 800 including a pair of optical modules 802 and 804. SmartNIC 800 comprises a Peripheral Component Interconnect Express (PCIe) card including a circuit board 806 having a PCIe edge connector 820 to which various integrated circuit (IC) chips and enhanced optical modules 802 and 804 are mounted. Alternatively, PCIe edge connector 820 may be replaced by another I/O interface, such as but not limited to CXL. The IC chips include an SmartNIC chip 808, an embedded processor 810 and memory chips 816 and 818. SmartNIC chip 808 is a multi-port Ethernet NIC that is configured to perform various Ethernet NIC functions, as is known in the art. In some embodiments, SmartNIC chip 808 is an FPGA and/or includes FPGA circuitry. SmartNIC chip 808 may include embedded logic for performing various packet processing operations, such as but not limited to packet classification, flow control, RDMA (Remote Direct Memory Access) operations, an Access Gateway Function (AGF), Virtual Network Functions (VNFs), a User Plane Function (UPF), and other functions. The optimized Montgomery and/or Barrett multiplication algorithms may be implemented using the programmable logic in SmartNIC chip 808 or via execution of software/firmware instructions on embedded processor 810. The optimized Montgomery multiplication algorithm 400 and/or the optimized Barrett multiplication algorithm 600 may be implemented by programming logic in SmartNIC chip 808 or via execution of software/firmware on embedded processor 810.

In addition to IPUs and SmartNICs, embodiments of the improved Montgomery and Barrett algorithms may be implemented on various types of add-in cards and other devices. Examples of such devices and add-in cards include but are not limited to line cards, switches, routers, cellular equipment (like nano-cells, picocells, ethernet connected radios), radio access network (RAN) equipment, WiFi equipment, network appliances, storage devices, security devices, servers with network ports, and telecom equipment.

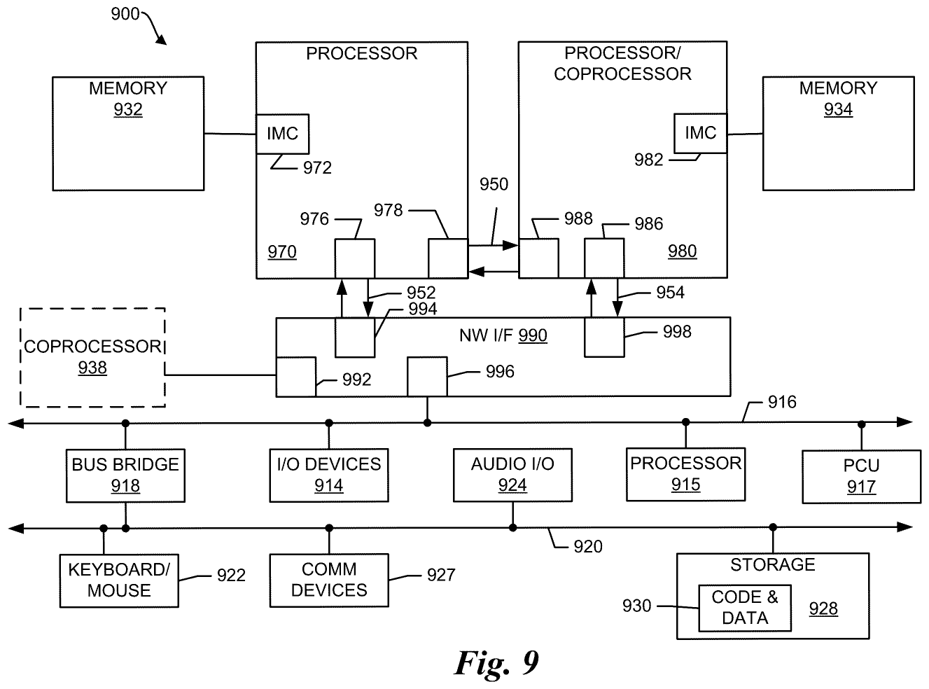

FIG. 9 illustrates an example computing system. System 900 is an interfaced system and includes a plurality of processors or cores including a first processor 970 and a second processor 980 coupled via an interface 950 such as a point-to-point (P-P) interconnect, a fabric, and/or bus. In some examples, the first processor 970 and the second processor 980 are homogeneous. In some examples, first processor 970 and the second processor 980 are heterogenous. Though the example system 900 is shown to have two processors, the system may have three or more processors, or may be a single processor system. In some examples, the computing system is a system on a chip (SoC).

Processors 970 and 980 are shown including integrated memory controller (IMC) circuitry 972 and 982, respectively. Processor 970 also includes interface circuits 976 and 978; similarly, second processor 980 includes interface circuits 986 and 988. Processors 970, 980 may exchange information via the interface 950 using interface circuits 978, 988. IMCs 972 and 982 couple the processors 970, 980 to respective memories, namely a memory 932 and a memory 934, which may be portions of main memory locally attached to the respective processors.

Processors 970, 980 may exchange information with a network interface (NW I/F) 990 via individual interfaces 952, 954 using interface circuits 976, 994, 986, 998. The network interface 990 (e.g., one or more of an interconnect, bus, and/or fabric, and in some examples is a chipset) may optionally exchange information with a coprocessor 938 via an interface circuit 992. In some examples, the coprocessor 938 is a special-purpose processor, such as, for example, a high-throughput processor, a network or communication processor, compression engine, graphics processor, general purpose graphics processing unit (GPGPU), neural-network processing unit (NPU), embedded processor, or the like.

Generally, in addition to processors and CPUs, the teaching and principles disclosed herein may be applied to Other Processing Units (collectively termed XPUs) including one or more of Graphic Processor Units (GPUs) or General Purpose GPUs (GP-GPUs), Tensor Processing Units (TPUs), Data Processing Units (DPUs), Infrastructure Processing Units (IPUs), Edge Processing Units (EPU), Artificial Intelligence (AI) processors or AI inference units and/or other accelerators, FPGAs and/or other programmable logic (used for compute purposes), etc. While some of the diagrams herein show the use of CPUs and/or processors, this is merely exemplary and non-limiting. Generally, any type of XPU may be used in place of a CPU or processor in the illustrated embodiments. Moreover, as used in the following claims, the term “processor” is used to generically cover CPUs and various forms of XPUs.

A shared cache (not shown) may be included in either processor 970, 980 or outside of both processors, yet connected with the processors via an interface such as P-P interconnect, such that either or both processors' local cache information may be stored in the shared cache if a processor is placed into a low power mode.

Network interface 990 may be coupled to a first interface 916 via interface circuit 996. In some examples, first interface 916 may be an interface such as a Peripheral Component Interconnect (PCI) interconnect, a PCI Express interconnect or another I/O interconnect, such as but not limited to COMPUTE EXPRESS LINK™ (CXL). In some examples, first interface 916 is coupled to a power control unit (PCU) 917, which may include circuitry, software, and/or firmware to perform power management operations with regard to the processors 970, 980 and/or coprocessor 938. PCU 917 provides control information to a voltage regulator (not shown) to cause the voltage regulator to generate the appropriate regulated voltage. PCU 917 also provides control information to control the operating voltage generated. In various examples, PCU 917 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 917 is illustrated as being present as logic separate from the processor 970 and/or processor 980. In other cases, PCU 917 may execute on a given one or more of cores (not shown) of processor 970 or 980. In some cases, PCU 917 may be implemented as a microcontroller (dedicated or general-purpose) or other control logic configured to execute its own dedicated power management code, sometimes referred to as P-code. In yet other examples, power management operations to be performed by PCU 917 may be implemented externally to a processor, such as by way of a separate power management integrated circuit (PMIC) or another component external to the processor. In yet other examples, power management operations to be performed by PCU 917 may be implemented within BIOS or other system software.

Various I/O devices 914 may be coupled to first interface 916, along with a bus bridge 918 which couples first interface 916 to a second interface 920. In some examples, one or more additional processor(s) 915, such as coprocessors, high throughput many integrated core (MIC) processors, GPGPUs, accelerators (such as graphics accelerators, digital signal processing (DSP) units, and cryptographic accelerator units), FPGAs, XPUs, or any other processor, are coupled to first interface 916. In some examples, second interface 920 may be a low pin count (LPC) interface. Various devices may be coupled to second interface 920 including, for example, a keyboard and/or mouse 922, communication devices 927 and storage circuitry 928. Storage circuitry 928 may be one or more non-transitory machine-readable storage media, such as a disk drive, Flash drive, SSD, or other mass storage device which may include instructions/code and data 930. Further, an audio I/O 924 may be coupled to second interface 920. Note that other architectures than the point-to-point architecture described above are possible. For example, instead of the point-to-point architecture, a system such as system 900 may implement a multi-drop interface or other such architecture.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (e.g., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
performing modular multiplication for first and second integers A and B, including,
employing a first operand for A and a second operand for B, the first and second operands having 2*k bits,
splitting A into k high bits AH and k low bits AL;
precomputing one of K_{M}=B*2^{-k} mod M or K_{B}=B*2^{k} mod M, where M is a 2*k-bit modulus;
multiplying one of AH*B or AL*B to obtain a first value;
multiplying one of AL*K_{M} or AH*K_{B} to obtain a second value; and
adding the first and second values to obtain C; and
performing a modular reduction on C.

2. The method of claim 1, wherein the modular multiplication comprises a Montgomery Multiplication that uses AH*B to obtain the first value and the modular reduction comprises a Montgomery Reduction.

3. The method of claim 2, further comprising:
splitting C into upper 2*k bits CH and lower k bits CL; and
using CH and CL to perform the Montgomery Reduction to obtain a residual that is a function of mod M.

4. The method of claim 3, further comprising:
calculating R=2^{2*L*w} mod M, where w is a digit size in bits and L is a number of digits of operands=[k/w]; and
calculating a residual RES=A*B*R⁻¹ mod M.

5. The method of claim 3, wherein w is a digit size in bits, L is a number of digits of operands=[k/w], and wherein the Montgomery Reduction is performed in L serial steps.

6. The method of claim 1, wherein the modular multiplication comprises a Barrett Multiplication that uses AH*L to obtain the first value and the modular reduction comprises a Barrett Reduction.

7. The method of claim 6, further comprising:
splitting C into upper k bits CH and lower 2*k bits CL; and
using CH and CL to perform the Barret Reduction to obtain a residual RES=A*B mod M.

8. The method of claim 7, wherein w is a digit size in bits, L is a number of digits of operands=[k/w], and wherein the Barrett Reduction is performed in L serial steps.

9. The method of claim 1, wherein multiplying AH*B or AL*B and multiplying AL*K_{M} or AH*K_{B} is done in parallel.

10. The method of claim 1, wherein the modular multiplication operations are interleaved with modular reduction operations.

11. A non-transitory machine-readable medium having instructions stored thereon to be executed on a processor or processor core of an apparatus to enable the apparatus to:
perform modular multiplication for first and second integers A and B, including,
employ a first operand for A and a second operand for B, the first and second operands having 2*k bits,
split A into k high bits AH and k low bits AL;
precompute K=B*2^{-k} mod M, where M is a k-bit modulus;
multiply one of AH*B or AL*B to obtain a first value;
multiply one of AL*K_{M} or AH*K_{B} to obtain a second value; and
add the first and second values to obtain C; and
perform a modular reduction on C.

12. The non-transitory machine-readable medium of claim 11, wherein the modular multiplication comprises a Montgomery Multiplication that uses AH*B to obtain the first value and the modular reduction comprises a Montgomery Reduction.

13. The non-transitory machine-readable medium of claim 11, wherein w is a digit size in bits, L is a number of digits of operands=[k/w], and wherein the modular reduction is performed in L serial steps.

14. The non-transitory machine-readable medium of claim 11, wherein the modular multiplication comprises a Barrett Multiplication that uses AL*B to obtain the first value and the modular reduction comprises a Barrett Reduction.

15. The non-transitory machine-readable medium of claim 14, wherein execution of the instructions further enables the apparatus to:
split C into upper k bits CH and lower 2*k bits CL; and
use CH and CL to perform the Barret Reduction to obtain a residual RES=A*B mod M.

16. The non-transitory machine-readable medium of claim 11, wherein the modular multiplication operations are interleaved with modular reduction operations.

17. An apparatus, comprising:
a processor, having one or more processor cores;
memory, coupled to the processor;
a plurality of instructions, to be executed on at least one of the one or more processor cores to an enable the apparatus to:
perform modular multiplication for first and second integers A and B, including,
employ a first operand for A and a second operand for B, the first and second operands having 2*k bits,
split A into k high bits AH and k low bits AL;
precompute one of K_{M}=B*2^{-k} mod M or K_{B}=B*2^{k} mod M, where M is a 2*k-bit modulus;
multiply one of AH*B or AL*B to obtain a first value;
multiply one of AL*K_{M} or AH*K_{B} to obtain a second value; and
add the first and second values to obtain C; and
perform a modular reduction on C.

18. The apparatus of claim 17, wherein the modular multiplication comprises a Montgomery Multiplication that uses AH*B to obtain the first value and the modular reduction comprises a Montgomery Reduction.

19. The apparatus of claim 17, wherein the modular multiplication comprises a Barrett Multiplication that uses AL*B to obtain the first value and the modular reduction comprises a Barrett Reduction.

20. The apparatus of claim 17, wherein the modular multiplication operations are interleaved with modular reduction operations.
